(19) United States
(12) Patent Application Publication
(10) Pub. No.: US 2016/0313538 A1
(43) Pub. Date: Oct. 27, 2016

(54) Photographic Lens System Enabling Reduction in Tightness of Manufacturing Tolerance

(71) Applicant: Sekonix Co., Ltd., Dongducheon-si (KR)

(72) Inventors: Ki-Youn Noh, Dongducheon-si (KR); Jung-Hee Whangbo, Yangju-si (KR); Sung-Nyun Kim, Incheon (KR)

(73) Assignee: Sekonix Co., Ltd., Dongducheon-si (KR)

(21) Appl. No.: 15/131,100

(22) Filed: Apr. 18, 2016

(30) Foreign Application Priority Data
Apr. 24, 2015 (KR) 10-2015-0058147

(51) Int. Cl. G02B 13/00; G03B 9/06; G02B 9/62

(52) U.S. Cl. CPC G02B 13/0045; G02B 9/62; G03B 9/06

(57) ABSTRACT

A photographic lens system includes first to sixth lenses arranged sequentially from an object along the optical axis. The first lens has positive refractive power, the second lens is meniscus shaped and has negative refractive power, the third lens has an upwardly-convex shape and positive refractive power, the fourth lens has an upwardly-convex shape and negative refractive power, the fifth lens has positive refractive power, and the sixth lens has negative refractive power. The photographic lens system satisfies −10<f2/f1<0 and L2te/L2tc<L16tc. The radius of curvature of an object-side lens surface of the third lens has a negative value, and the radius of curvature of an image-side surface of the third lens has a negative value. This reduces the tightness of manufacturing tolerance while reducing the size and weight of the lens system, thereby improving the reproducibility of performance of the lens system.

### BACKGROUND OF THE INVENTION

1. Field of the Invention

The present invention generally relates to a photographic lens system including a total of six lenses. More particularly, the present invention relates to a photographic lens system enabling reduction in tightness of manufacturing tolerance, in which the refractive power, shapes, and focal lengths of the lenses are set such that the refractive power concentrated on first and second lenses is distributed, thereby reducing the size and weight of the photographic lens system, enabling reduction in the tightness of manufacturing tolerance of the photographic lens system, and improving the reproducibility of performance of the photographic lens system.

2. Description of the Related Art

Recently, uses of mobile phone cameras and digital cameras are increasing, and demands for a wider range of services, for example, demands for image capturing, image transmission, or video communications are increasing.

In particular, the demand for photographic lens units for mobile phone cameras is increasing. Mobile phones in which digital camera technology and mobile phone technology are converged, i.e. so-called camera phones or camera mobile phones, are attracting great interest. Due to demands for high performance, studies on camera modules having imaging elements of 3 mega pixels or more are more actively being performed.

In order to realize high-quality and high-performance functions of 3 mega pixels or more, at least three to six lenses must be used.

Related-art approaches in response to such high-quality and high-performance demands include the followings:

U.S. Pat. No. 8,395,851 disclosed an optical lens system including five lenses arranged sequentially from an object, in which the second lens has negative refractive power, and the lenses satisfy predetermined conditions, such as focal lengths, radii of curvature, and Abbe numbers.

Japanese Unexamined Patent Publication No. Hei 08-262322 disclosed a wide-angle lens system including first to fourth lenses arranged sequentially from an object, in which the first lens has negative refractive power, the second lens has positive refractive power, and the third and fourth lenses are formed of synthetic resin and have positive refractive power, such that combined focal lengths and Abbe numbers satisfy predetermined conditions.

Korean Patent No. 10-0711024 disclosed a micro high-definition laminated photographic lens system including first to fourth lenses. The first to fourth lenses form a lens assembly in which the first lens has positive refractive power, the second lens has negative refractive power, the first and second lenses are formed of optical glass, both the front surface of the first lens and the rear surface of the second lens are spherical, and the rear surface of the first lens and the front surface of the second lens are substantially planar and are bonded to each other.

Korean Patent No. 10-1158419 disclosed a lens system including a total of five lenses. The lenses are configured such that the second lens has negative refractive power, and that the focal lengths, radii of curvature, and the like of the lenses satisfy predetermined conditions.

In addition, Korean Patent No. 10-1429895 disclosed a compact wide-angle lens system including a total of six lenses, in which the focal lengths of the first and second lenses are set, and the levels of refractive power of the lenses are set.

In the above-mentioned photographic lens systems of the related art, refractive power is concentrated on the first lens and/or the second lens in most cases. Since the refractive power of the lens system is highly dependent on the levels of refractive power of the first lens and the second lens, the tolerance of the lens systems is too tight, which is problematic.

In particular, when the tolerance of a micro photographic lens system is too tight, products may have different performance. Studies on improving the reproducibility of performance of products in an easy manner by enabling reduction in the tightness of manufacturing tolerance of the entire lens system are required.

The information disclosed in the Background of the Invention section is only for the enhancement of understanding of the background of the invention, and should not be taken as an acknowledgment or as any form of suggestion that this information forms a prior art that would already be known to a person skilled in the art.

### RELATED ART DOCUMENTS

Patent Document 1: U.S. Pat. No. 8,395,851
Patent Document 2: Japanese Unexamined Patent Publication No. Hei 08-262322
Patent Document 3: Korean Patent No. 10-0711024
Patent Document 4: Korean Patent No. 10-1158419
Patent Document 5: Korean Patent No. 10-1429895

### SUMMARY OF THE INVENTION

Accordingly, the present invention has been made keeping in mind the above problems occurring in the related art, and the present invention is intended to propose a photographic lens system enabling reduction in tightness of manufacturing tolerance and including a total of six lenses, in which the refractive power, shapes, and focal lengths of the lenses are set such that the refractive power concentrated on first and second lenses is distributed, thereby reducing the size and weight of the photographic lens system, enabling reduction in the tightness of manufacturing tolerance of the photographic lens system, and improving the reproducibility of performance of the photographic lens system.

In order to achieve the above object, according to one aspect of the present invention, a photographic lens system may include first, second, third, fourth, fifth, and sixth lenses arranged sequentially from an object along an optical axis thereof. The first lens has positive refractive power, the second lens is meniscus shaped and has negative refractive power, the third lens has an upwardly-convex shape and positive refractive power, the fourth lens has an upwardly-convex shape and negative refractive power, the fifth lens has positive refractive power, and the sixth lens has negative refractive power. The photographic lens system satisfies the following relationship: −10<f2/f1<0, where f1 is a focal length of the first lens, and f2 is a focal length of the second lens. The lenses satisfy the following relationship: L2te/L2tc<L16tc, where L2te is a thickness of the second lens at an effective diameter of a rear surface thereof, L2tc is a center thickness of the second lens, and L16tc is a length from an object-side surface of the first lens to an image-side surface of the sixth lens along the optical axis. The radius of curvature of an object-side lens surface of the third lens has a negative value, and the radius of curvature of an image-side surface of the third lens has a negative value. The tightness of manufacturing tolerance of the photographic lens system is reduced.

The photographic lens system may satisfy the following relationship: |v2−v4|<v3, where v2 is an Abbe number of the second lens, v3 is an Abbe number of the third lens, and v4 is an Abbe number of the fourth lens.

The photographic lens system may further include an iris diaphragm disposed in front of the first lens.

The photographic lens system may satisfy the following relationship: 1<|R_L1S2/R_L1S1|, where R_L1S1 is a radius of curvature of a front surface of the first lens, and R_L1S2 is a radius of curvature of a rear surface of the first lens.

The photographic lens system may satisfy the following relationship: 1<|R_L1S2/R_L1S1|<10, where R_L1S1 is a radius of curvature of a front surface of the first lens, and R_L1S2 is a radius of curvature of a rear surface of the first lens.

The photographic lens system may satisfy the following relationship: 0.5<TL/f<2, where TL is a thickness of the first lens from an object-side surface to an image-side surface thereof, and f is a combined focal length of the photographic lens system.

At least one surface of the first lens may be aspherical, both surfaces of the second lens may be aspherical, at least one surface of each of the third to fifth lenses may be aspherical, and the sixth lens may have a plurality of inflection points, with both surfaces thereof being aspherical. One of the first to sixth lenses may be formed of a different material from the other lenses.

According to the present invention as set forth above, the photographic lens system including a total of five lenses is applicable to camera system, such as a mobile phone camera, a digital camera, a PC camera, and the like, in order to miniaturize the camera system and allow the camera system to obtain high-definition images.

In addition, according to the present invention, the photographic lens system includes a total of six lenses, in which the refractive power, shapes, and focal lengths of the lenses are set such that the refractive power concentrated on first and second lenses is distributed, thereby reducing the size and weight of the photographic lens system, reducing the tightness of manufacturing tolerance of the photographic lens system, and improving the reproducibility of performance of the photographic lens system, whereby the tightness of manufacturing tolerance of the photographic lens system is reduced.

Furthermore, according to the present invention, in the photographic lens system, the effective diameter of the second lens with respect to the thickness of the entire lens system and the center thickness of the second lens are set such that the tightness of manufacturing tolerance of the photographic lens system is reduced by reducing the dependence on the refractive power of the second lens. In addition, the ratios of the focal lengths of the first and second lenses are set such that the tightness of manufacturing tolerance of the photographic lens system is reduced. It is thereby possible to miniaturize the photographic lens system while reducing the tightness of manufacturing tolerance of fabrication of the photographic lens system, thereby further improving the performance reproducibility of the photographic lens system.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will be more clearly understood from the following detailed description when taken in conjunction with the accompanying drawings, in which:

FIG. 1 is a cross-sectional diagram illustrating a first exemplary embodiment of a photographic lens system enabling reduction in tightness of manufacturing tolerance according to the present invention;

FIG. 2 is a graph illustrating aberrations according to the first exemplary embodiment of the present invention;

FIG. 3 is a cross-sectional diagram illustrating a second exemplary embodiment of a photographic lens system enabling reduction in tightness of manufacturing tolerance according to the present invention; and

FIG. 4 is a graph illustrating aberrations according to the second exemplary embodiment of the present invention.

### DETAILED DESCRIPTION OF THE INVENTION

The present invention relates to a photographic lens system including a total of six lenses, in which first, second, third, fourth, and sixth lenses are arranged sequentially from an object along the optical axis.

In particular, the present invention provides the photographic lens system consisting of a total of six lenses, in which refractive power concentrated on the first and second lenses is distributed, the size and weight of the photographic lens system are reduced, the tightness of manufacturing tolerance of the photographic lens system is reduced, and the performance reproducibility of the photographic lens system is improved.

Hereinafter, the present invention will be described in greater detail with reference to the accompanying drawings.

The present invention relates to the photographic lens system enabling reduction in tightness of manufacturing tolerance, in which the first to sixth lenses are arranged sequentially from an object along the optical axis. The first lens has positive refractive power, the second lens is meniscus shaped and has negative refractive power, the third lens has an upwardly-convex shape and positive refractive power, the fourth lens has an upwardly-convex shape and negative refractive power, the fifth lens has positive refractive power, and the sixth lens has negative refractive power.

Consequently, positive and negative refractive power levels are uniformly distributed in the lenses of the lens system, thereby realizing high performance suitable to a high-definition lens system.

In particular, in order to correct chromatic aberrations, the lens system is configured such that the first lens for correction aberration has high positive refractive power, the second lens has low negative refractive power due to the meniscus shape thereof, the third lens has positive refractive power, the fourth lens has negative refractive power, the fifth lens has positive refractive power, and the sixth lens has negative refractive power. In this manner, distortion is corrected and the impressions of colors of the central and peripheral portions are improved, thereby realizing the high-definition of the lens system. That is, the first lens has high positive refractive power, while the second to sixth lenses act as aberration correction lenses in the entire lens system.

In addition, the sixth lens is embodied as a double-side aspherical lens having low negative refractive power and a plurality of inflection points. Specifically, the sixth lens is designed to have one or more inflection points, in which the central portion of the surface of the sixth lens facing toward the object (the object-side surface of the sixth lens) is convex toward the object, the object-side surface of the sixth lens becomes gradually concave from the central portion to the periphery, the central portion of the surface of the sixth lens facing an image (the image-side surface of the sixth lens) is concave toward the object, and the image-side surface of the sixth lens becomes gradually convex from the central portion to the periphery.

The sixth lens having this configuration can reduce the angle of a main beam, such that various aberrations and distortions can be corrected.

The lens system having the above-described refractive power and configuration is characterized by satisfying relationships: −10<f2/f1<0 and L2te/L2tc<L16tc.

Here, f1 indicates the focal length of the first lens, f2 indicates the focal length of the second lens, L2te indicates the thickness of the second lens at the effective diameter of the rear surface of the second lens, L2tc indicates the center thickness of the second lens, and L16tc indicates the length from the object-side surface of the first lens to the image-side surface of the sixth lens along the optical axis.

In the relationship: −10<f2/f1<0, the focal length of the first lens and the focal length of the second lens have opposite signs (for example, when the focal length of the first lens is positive, the focal length of the second lens is negative) and the focal length of the second lens, and the ratio of the focal length of the first lens with respect to the focal length of the second lens is less than 10. As the focal length ratio is reduced, a compact lens system can be provided. That is, even in the case in which the focal length ratio is reduced, the tightness of manufacturing tolerance of the photographic lens system can be reduced.

In the relationship: L2te/L2tc<L16tc, the ratio of the center thickness L2tc of the second lens with respect to the thickness L2te of the second lens at the effective diameter of the rear surface of the second lens is smaller than the length L16tc from the object-side surface of the first lens to the image-side surface of the sixth lens along the optical axis.

These requirements define the shape of the second lens, which is designed such that the difference in the thickness between the central portion and the peripheral portion of the second lens is small. Consequently, the tightness of manufacturing tolerance can be reduced, thereby improving the reproducibility of performance.

The photographic lens system enabling reduction in tightness of manufacturing tolerance according to the present invention is designed such that an iris diaphragm is disposed in front of the object-side surface of the first lens in order to lower the angle of a main beam while reducing sensitivity to the tolerance of fabrication. This can reduce the length of the entire lens system, thereby miniaturizing the lens system.

In addition, the photographic lens system enabling reduction in tightness of manufacturing tolerance according to the present invention is characterized by |v2−v4|<v3. Here, v2 is the Abbe number of the second lens, v3 is an Abbe number of the third lens, and v4 is the Abbe number of the fourth lens. That is, the second to fourth lenses are designed such that the difference in the Abbe number between the second lens and the fourth lens does not exceed the Abbe number of the third lens. This configuration is intended to pursue miniaturization while removing chromatic aberrations and realizing high definition. The lenses are designed to be formed of a material having a relatively-small Abbe number (a large value of distribution) while the difference in the Abbe number between the second lens and the fourth lens does not exceed the Abbe number of the third lens. This configuration consequently reduces the tightness of manufacturing tolerance as well as chromatic aberration.

Furthermore, the photographic lens system enabling reduction in tightness of manufacturing tolerance according to the present invention satisfies the relationship: 1<|R_L1S2/R_L1S1|, where R_L1S1 is the radius of curvature of the front surface of the first lens, and R_L1S2 is the radius of curvature of the rear surface of the first lens.

This defines the shape of the first lens, i.e. the focal length is reduced by reducing the radius of curvature of the front surface of the first lens, whereby the entire lens system is miniaturized and the tightness of manufacturing tolerance thereof is reduced.

In addition, the photographic lens system enabling reduction in tightness of manufacturing tolerance according to the present invention satisfies the relationship: 1<|R_L1S2/R_L1S1|<10, where R_L1S1 is the radius of curvature of the front surface of the first lens, and R_L1S2 is the radius of curvature of the rear surface of the first lens.

This further defines the shape of the first lens, i.e. reduces the tightness of manufacturing tolerance by reducing dependence on power such that the first lens has no influence.

In addition, the photographic lens system enabling reduction in tightness of manufacturing tolerance according to the present invention satisfies the relationship: 1<|R_L2S1/R_L2S2|<10, where R_L2S1 is the radius of curvature of the front surface of the second lens, and R_L2S2 is the radius of curvature of the rear surface of the second lens.

This defines the shape of the second lens, which reduces dependence on refractive power such that the second lens has no influence, thereby reducing the tightness of manufacturing tolerance. The second lens is designed into the shape of a meniscus and has negative refractive power in order to further reduce the tightness of manufacturing tolerance, thereby improving the reproducibility of the lens system.

Furthermore, the photographic lens system enabling reduction in tightness of manufacturing tolerance according to the present invention satisfies the relationship: 0.5<TL/f<2, where TL is the thickness from the object-side surface to the image surface of the first lens, and f is the combined focal length of the entire lens system.

This defines the ratio of the combined focal length of the entire lens system with respect to the thickness from the object-side surface to the image surface of the first lens, such that aberrations can be corrected and the lens system can be miniaturized.

In addition, the photographic lens system enabling reduction in tightness of manufacturing tolerance according to the present invention is characterized in that at least one surface of the first lens is aspherical, at least one surface of each of the third to fifth lenses is aspherical, and the sixth lens has a plurality of inflection points, with both surfaces thereof being aspherical. One of the first to sixth lenses is formed of a different material.

It is preferable that at least one surface of each of the lenses is aspherical in order to correct aberrations. The lenses are formed of different materials, such as glass or plastic, which are combined suitably, in order to correct chromatic aberrations. Each of the lenses is formed of a material having high refractive power, which helps reduce the length of the lens system. The lenses are formed of materials, the Abbe numbers of which differ from each other, so as to be advantageous in correcting chromatic aberrations.

The shapes and materials of the first to sixth lenses as described above are intended to improve the performance of an optical system and reduce the overall size of the optical system by minimizing the spherical aberrations, coma aberrations, curvatures of fields, distortion aberrations, and chromatic aberrations.

Hereinafter, exemplary embodiments of the present invention will be described.

### First Embodiment

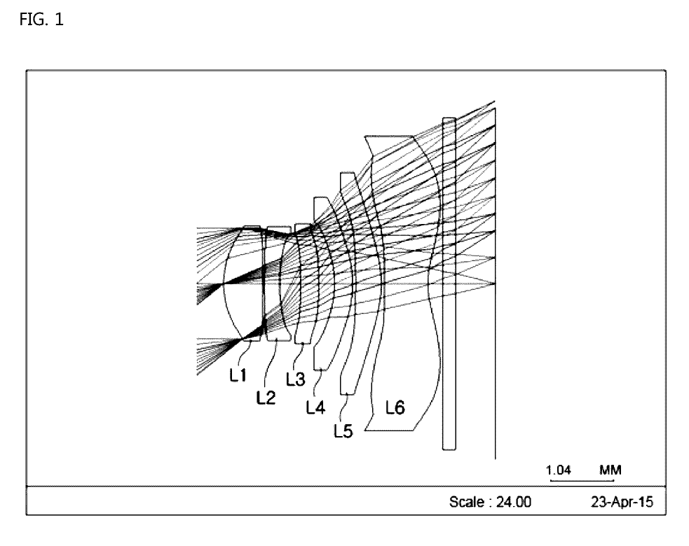

FIG. 1 is a cross-sectional diagram illustrating a first exemplary embodiment of a photographic lens system enabling reduction in tightness of manufacturing tolerance according to the present invention;

As illustrated in FIG. 1, the photographic lens system includes an iris diaphragm, a first lens L1, a second lens L2, a third lens L3, a fourth lens L4, a fifth lens L5, and a sixth lens L6 that are arranged sequentially from an object along the optical axis.

Table 1 represents numerical data of the lenses of the optical system according to the first embodiment of the present invention.

TABLE 1

| | Radius of | | Refractive | Abbe |
|---|---|---|---|---|
| Lens | curvature | Thickness | index | number |
| surface | (mm) | (mm) | (Nd) | (Vd) |
| L1R1 | 1.417584 | 0.645156 | 1.5441 | 56 |
| L1R2 | 8.324033 | 0.031599 | 1 | 0 |
| L2R1 | 5.263115 | 0.25 | 1.6355 | 23 |
| L2R2 | 2.639185 | 0.345261 | 1 | 0 |
| L3R1 | −625.406915 | 0.301635 | 1.5441 | 56 |
| L3R2 | −7.405531 | 0.263333 | 1 | 0 |
| L4R1 | −1.457352 | 0.297902 | 1.6355 | 23 |
| L4R2 | −1.888702 | 0.05 | 1 | 0 |
| L5R1 | −15.421125 | 0.426009 | 1.5311 | 56 |
| L5R2 | −1.710644 | 0.05 | 1 | 0 |
| L6R1 | 13.902674 | 0.719105 | 1.5311 | 56 |
| L6R2 | 1.285152 | 0.25 | 1 | 0 |
| Filter | infinity | 0.21 | BK7 | |
| Filter | infinity | 0.660688 | 1 | 0 |
| Image | infinity | 0 | | 0 |

As illustrated in FIG. 1, the first lens L1, the second lens L2, the third lens L3, the a fourth lens L4, the fifth lens L5, and the sixth lens L6 are arranged from the object, in which an aspherical formula is expressed as Formula (1):

$$x ( Y ) = \frac{{Y}^{2}}{R} \frac{1}{1 + \sqrt{1 - ( 1 + K ) {( \frac{Y}{R} )}^{2}}} + {A}_{3} {Y}^{4} + {A}_{4} {Y}^{6} + {A}_{5} {Y}^{8} + {A}_{6} {Y}^{10} + … + {A}_{14} {Y}^{26} , \qquad Formula ( 1 )$$

where X is set as the direction of the optical axis, Y is set as the direction perpendicular to the optical axis.

An aspherical surface is a curved surface produced by rotating a curved line, obtained by the aspherical formula of Formula (1), around the optical axis, in which R is the radius of curvature, K is a conic constant, and A₃, A₄, A₅, A₆, . . . , and A₁₄ are aspherical coefficients.

Aspherical coefficients having data of the lenses derived from Formula (1) are presented in Table 2.

TABLE 2

| L1S1 | L1S2 | L2S1 | L2S2 | L3S1 | L3S2 |
|---|---|---|---|---|---|
| 1.417584058 | 8.324032971 | 5.263114908 | 2.63918455 | −625.4069153 | −7.405530608 |
| −0.248529709 | 0 | 0 | 3.697333276 | 0 | 0 |
| 0.009165822 | −0.366868186 | −0.399532893 | −0.131180859 | −0.176244091 | −0.059107106 |
| −0.011619103 | 0.874791167 | 1.004297078 | 0.309877591 | −0.163822198 | −0.295160326 |
| 0.064892891 | −1.086060606 | −1.057341439 | −0.218541679 | 0.324365872 | 0.409268474 |
| −0.221481133 | 0.41473023 | 0.248911776 | 0.166702133 | −0.369895877 | −0.302871468 |
| 0.291910836 | 0.141788841 | 0.325659022 | −0.225947969 | 0.389202423 | 0.178720122 |
| −0.174943546 | −0.120207679 | −0.14812313 | 0.302388531 | −0.02029764 | 0.005740402 |

| L4S1 | L4S2 | L5S1 | L5S2 | L6S1 |
|---|---|---|---|---|
| −1.457352246 | −1.888702336 | −15.42112543 | −1.710643508 | 13.90267403 |
| −5.746384384 | 0.218468039 | 86.48580576 | −9.698048902 | −99 |
| | | | | −0.011208093 |
| 0.003171898 | 0.037286226 | −0.016518883 | 0.00357776 | −0.17729422 |
| | | | | 0.003867209 |
| −0.068915842 | 0.04521954 | −0.013556304 | 0.000284387 | 0.092013598 |
| | | | | 0.002389198 |
| 0.060544303 | −0.017749781 | −0.000628641 | −0.000680065 | −0.019706602 |
| | | | | −0.001114504 |
| −0.076513607 | 0.011055955 | 0.001309686 | −9.37793114E−05 | 0.001572489 |
| | | | | −1.09848532E−06 |
| 0.087093904 | −0.011621515 | 0.000341784 | 5.72473091E−05 | 4.76245964E−05 |
| | | | | 9.80022864E−05 |
| −0.052079272 | 0.003348819 | 0 | 0 | −4.26900760E−05 |

Table 3 represents the focal lengths, minimum diameters, center thicknesses, and edge thicknesses of the lenses.

TABLE 3

| | Focal | Minimum | Center | Edge |
|---|---|---|---|---|
| | length | diameter | Thickness | Thickness |
| L1 | 3.029988 | 1.8403 | 0.645156 | 0.284843 |
| L2 | −8.58481 | 1.7945 | 0.25 | 0.391786 |
| L3 | 13.72657 | 1.8905 | 0.301635 | 0.25077 |
| L4 | −13.6415 | 2.3899 | 0.297902 | 0.333582 |
| L5 | 3.572255 | 3.1 | 0.426009 | 0.331571 |
| L6 | −2.71116 | 4.6 | 0.719105 | 0.867761 |
| Lens System | 3.78 | 5.868 | 4.5 | |

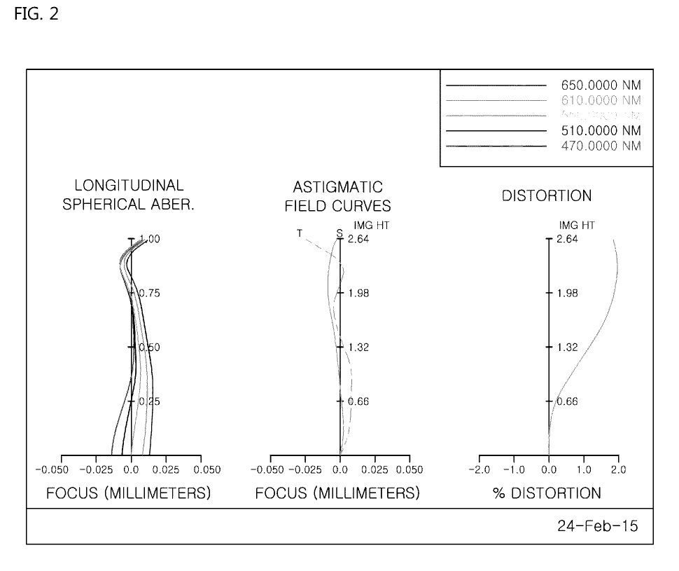

FIG. 2 is a graph illustrating aberrations according to the first exemplary embodiment of the present invention.

The first data of FIG. 2 illustrates spherical aberrations, in which the horizontal axis indicates focuses (mm), the vertical axis indicates image heights (mm), and colors indicate wavelengths of incident light. As illustrated in FIG. 2, it is known that the ability to correct spherical aberrations is higher as the graph is closer to the central vertical axis. According to the first embodiment of the present invention, the spherical aberrations are equal to or less than 0.025 mm (focus), which is considered satisfactory.

The second data of FIG. 2 illustrate an astigmatism, in which the horizontal axis indicates focuses (mm), the vertical axis indicates image heights (mm), curve S indicates sagittal beams parallel to the lenses, and curve T indicates tangential beams perpendicular to the lenses. Here, the ability to correct the astigmatism is higher as curves S and T are closer to each other and are closer to the central vertical axis. According to the first embodiment of the present invention, the astigmatism is equal to or less than 0.025 mm (focus), which is considered satisfactory.

The third data of FIG. 2 illustrate distortions, in which the horizontal axis indicates the degree of distortion (%), and the vertical axis indicates image heights (mm). It is known to be satisfactory when an aberration curve ranges from −2% to 2%. Optical distortions, which are distortions according to the first embodiment of the present invention, are equal to or less than 2%, which is considered satisfactory.

### Second Embodiment

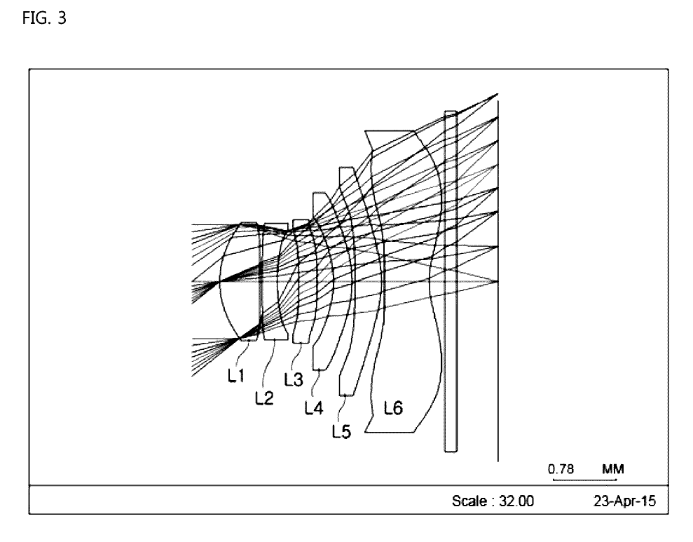

FIG. 3 is a cross-sectional diagram illustrating a second exemplary embodiment of a photographic lens system enabling reduction in tightness of manufacturing tolerance according to the present invention.

As illustrated in FIG. 3, the photographic lens system includes an iris diaphragm, a first lens L1, a second lens L2, a third lens L3, a fourth lens L4, a fifth lens L5, and a sixth lens L6 that are arranged sequentially from an object along the optical axis.

Table 4 represents numerical data of the lenses of the optical system according to the second embodiment of the invention.

TABLE 4

| | Radius of | | Refractive | Abbe |
|---|---|---|---|---|
| Lens | curvature | Thickness | index | number |
| surface | (mm) | (mm) | (Nd) | (Vd) |
| L1R1 | 1.10288 | 0.501931 | 1.5441 | 56 |
| L1R2 | 6.476098 | 0.024584 | 1 | 0 |
| L2R1 | 4.094703 | 0.1945 | 1.6355 | 23 |
| L2R2 | 2.053286 | 0.268613 | 1 | 0 |
| L3R1 | −486.567 | 0.234672 | 1.5441 | 56 |
| L3R2 | −5.7615 | 0.204873 | 1 | 0 |
| L4R1 | −1.13382 | 0.231768 | 1.6355 | 23 |
| L4R2 | −1.46941 | 0.0389 | 1 | 0 |
| L5R1 | −11.9976 | 0.331435 | 1.5311 | 56 |
| L5R2 | −1.33088 | 0.0389 | 1 | 0 |
| L6R1 | 10.81628 | 0.559464 | 1.5311 | 56 |
| L6R2 | 0.999849 | 0.1945 | 1 | 0 |
| Filter | | 0.16338 | BK7 | |
| Filter | | 0.514015 | 1 | 0 |
| Image | | 0 | | 0 |

As illustrated in FIG. 3, the first lens L1, the second lens L2, the third lens L3, the a fourth lens L4, the fifth lens L5, and the sixth lens L6 are arranged from the object, in which an aspherical formula is expressed as Formula (1), where X is set as the direction of the optical axis, Y is set as the direction perpendicular to the optical axis. In this case, an aspherical surface is a curved surface produced by rotating a curved line, obtained by the aspherical formula of Formula (1), around the optical axis, in which R is the radius of curvature, K is a conic constant, and A₃, A₄, A₅, A₆, . . . , and A₁₄ are aspherical coefficients.

Aspherical coefficients having data of the lenses derived from Formula (1) are presented in Table 5.

TABLE 5

| L1S1 | L1S2 | L2S1 | L2S2 | L3S1 | L3S2 |
|---|---|---|---|---|---|
| 1.102880397 | 6.476097652 | 4.094703398 | 2.05328558 | −486.5665801 | −5.761502813 |
| −0.248529709 | 0 | 0 | 3.697333276 | 0 | 0 |
| 0.019464025 | −0.779060636 | −0.84842557 | −0.278568292 | −0.374262035 | −0.125516525 |
| −0.040763794 | 3.069067247 | 3.523418369 | 1.087156799 | −0.574744422 | −1.035523587 |
| 0.376131705 | −6.295016635 | −6.12855481 | −1.266709702 | 1.880087123 | 2.372198972 |
| −2.12090084 | 3.971452014 | 2.383576363 | 1.596337751 | −3.542118755 | −2.90029377 |
| 4.618220344 | 2.243192204 | 5.152138722 | −3.574644649 | 6.157436881 | 2.827469222 |
| −4.572599499 | −3.141936835 | −3.871578939 | 7.903701956 | −0.53053103 | 0.150040183 |

| L4S1 | L4S2 | L5S1 | L5S2 | L6S1 |
|---|---|---|---|---|
| −1.133820047 | −1.469410417 | −11.99763559 | −1.330880649 | 10.8162804 |
| −5.746384384 | 0.218468039 | 86.48580576 | −9.698048902 | −99 |
| | | | | −0.018517082 |
| 0.006735663 | 0.079178932 | −0.035078571 | 0.00759753 | −0.376492029 |
| | | | | 0.01055551 |
| −0.241780396 | 0.158645647 | −0.047560162 | 0.000997727 | 0.322815237 |
| | | | | 0.010773941 |
| 0.350926452 | −0.102881153 | −0.003643727 | −0.00394179 | −0.114223264 |
| | | | | −0.00830319 |
| −0.732693435 | 0.105871698 | 0.012541535 | −8.98029630E−04 | 0.015058135 |
| | | | | −1.35206723E−05 |
| 1.377882524 | −0.183859969 | 0.005407243 | 9.05689871E−04 | 7.53452262E−04 |
| | | | | 1.99287952E−03 |
| −1.361225717 | 0.087529992 | 0 | 0 | −1.11581493E−03 |

Table 6 represents the focal lengths, minimum diameters, center thicknesses, and edge thicknesses of the lenses.

TABLE 6

| | Focal | Minimum | Center | Edge |
|---|---|---|---|---|
| | length | diameter | Thickness | Thickness |
| L1 | 2.357331 | 1.4319 | 0.501931 | 0.221596 |
| L2 | −6.67899 | 1.3962 | 0.1945 | 0.3048 |
| L3 | 10.67927 | 1.5009 | 0.234672 | 0.194581 |
| L4 | −10.6131 | 1.9953 | 0.231768 | 0.227971 |
| L5 | 2.779215 | 2.6277 | 0.331435 | 0.210816 |
| L6 | −2.10928 | 3.6986 | 0.559464 | 0.545483 |
| Lens System | 2.9408 | 4.566 | 3.5 | |

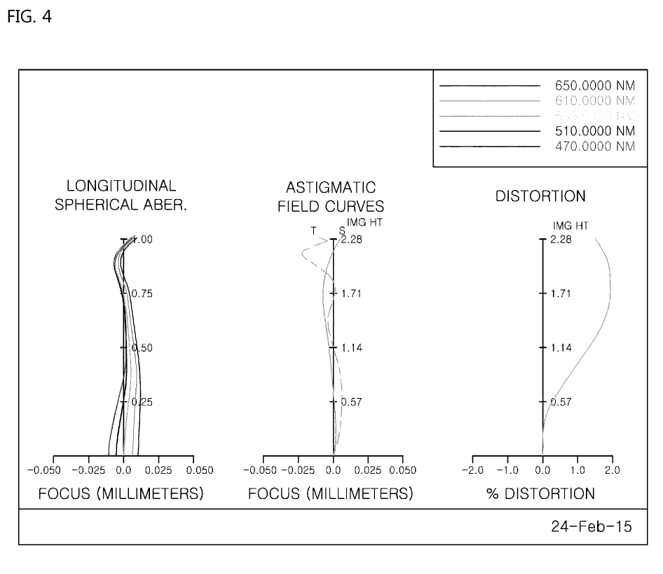

FIG. 4 is a graph illustrating aberrations according to the second exemplary embodiment of the present invention.

The first data of FIG. 4 illustrates spherical aberrations, in which the horizontal axis indicates focuses (mm), the vertical axis indicates image heights (mm), and colors indicate wavelengths of incident light. As illustrated in FIG. 4, it is known that the ability to correct spherical aberrations is higher as the graph is closer to the central vertical axis. According to the second embodiment of the invention, the spherical aberrations are equal to or less than 0.025 mm (focus), which is considered satisfactory.

The second data of FIG. 4 illustrate an astigmatism, in which the horizontal axis indicates focuses (mm), the vertical axis indicates image heights (mm), curve S indicates sagittal beams parallel to the lenses, and curve T indicates tangential beams perpendicular to the lenses. Here, the ability to correct the astigmatism is higher as curves S and T are closer to each other and are closer to the central vertical axis. According to the second embodiment of the invention, the astigmatism is equal to or less than 0.025 mm (focus), which is considered satisfactory.

The third data of FIG. 4 illustrate distortions, in which the horizontal axis indicates the degree of distortion (%), and the vertical axis indicates image heights (mm). It is known to be satisfactory when an aberration curve ranges from −2% to 2%. Optical distortions, which are distortions according to the second embodiment of the invention, are equal to or less than 2%, which are considered satisfactory.

Although the exemplary embodiments of the present invention have been described for illustrative purposes, a person skilled in the art will appreciate that various modifications, additions and substitutions are possible, without departing from the scope and spirit of the present invention as disclosed in the accompanying claims.

What is claimed is:

1. A photographic lens system comprising first, second, third, fourth, fifth, and sixth lenses arranged sequentially from an object along an optical axis thereof,
wherein the first lens has positive refractive power, the second lens is meniscus shaped and has negative refractive power, the third lens has an upwardly-convex shape and positive refractive power, the fourth lens has an upwardly-convex shape and negative refractive power, the fifth lens has positive refractive power, and the sixth lens has negative refractive power,
wherein the photographic lens system satisfies the following relationship: −10<f2/f1<0, where f1 is a focal length of the first lens, and f2 is a focal length of the second lens,
wherein the lenses satisfy the following relationship: L2te/L2tc<L16tc, where L2te is a thickness of the second lens at an effective diameter of a rear surface thereof, L2tc is a center thickness of the second lens, and L16tc is a length from an object-side surface of the first lens to an image-side surface of the sixth lens along the optical axis, and
wherein a radius of curvature of an object-side lens surface (L3R1) of the third lens has a negative value, and a radius of curvature of an image-side surface (L3R2) of the third lens has a negative value,
whereby tightness of manufacturing tolerance of the photographic lens system is reduced.

2. The photographic lens system according to claim 1, wherein the photographic lens system satisfies the following relationship: |v2−v4|<v3, where v2 is an Abbe number of the second lens, v3 is an Abbe number of the third lens, and v4 is an Abbe number of the fourth lens.

3. The photographic lens system according to claim 1, further comprising an iris diaphragm disposed in front of the first lens.

4. The photographic lens system according to claim 1, wherein the photographic lens system satisfies the following relationship: 1<|R_L1S2/R_L1S1|, where R_L1S1 is a radius of curvature of a front surface of the first lens, and R_L1S2 is a radius of curvature of a rear surface of the first lens.

5. The photographic lens system according to claim 1, wherein the photographic lens system satisfies the following relationship: 1<|R_L1S2/R_L1S1|<10, where R_L1S1 is a radius of curvature of a front surface of the first lens, and R_L1S2 is a radius of curvature of a rear surface of the first lens.

6. The photographic lens system according to claim 1, wherein the photographic lens system satisfies the following relationship: 1<|R_L2S1/R_L2S2|<10, where R_L2S1 is a radius of curvature of a front surface of the second lens, and R_L2S2 is a radius of curvature of a rear surface of the second lens.

7. The photographic lens system according to claim 1, wherein the photographic lens system satisfies the following relationship: 0.5<TL/f<2, where TL is a thickness of the first lens from an object-side surface to an image-side surface thereof, and f is a combined focal length of the photographic lens system.

8. The photographic lens system according to claim 1, wherein at least one surface of the first lens is aspherical, both surfaces of the second lens are aspherical, at least one surface of each of the third to fifth lenses is aspherical, and the sixth lens has a plurality of inflection points, with both surfaces thereof being aspherical.

9. The photographic lens system according to claim 1, wherein one of the first to sixth lenses is formed of a different material from the other lenses.
